(19) United States
(12) Patent Application Publication
(10) Pub. No.: US 2019/0181640 A1
(43) Pub. Date: Jun. 13, 2019

(54) Technology for the Decentralized Storage of Energy

(71) Applicant: i-select SA, Neuchatel (CH)

(72) Inventor: Christian Muhr, Kefferhausen (DE)

(73) Assignee: i-select SA, Neuchatel (CH)

(21) Appl. No.: 16/214,083

(22) Filed: Dec. 9, 2018

(30) Foreign Application Priority Data
Dec. 13, 2017 (DE) 102017129744.8

(51) Int. Cl. H02J 3/28; H02J 3/38; F28D 20/02

(52) U.S. Cl. CPC H02J 3/28; F28D 20/028; H02J 3/383; H02J 3/386

(57) ABSTRACT

A method for the decentralized storage of energy, wherein the energy is provided by at least one centrally arranged energy generation device for generating electrical energy includes providing at least one heat storage device that is decentrally arranged with respect to energy generation facility and electrically coupled to an energy generation facility; receiving a signal, provided by the energy generation facility, by at least one heat storage device, the signal indicating the presence of excess electrical energy at the energy generation facility; detecting the current discharge state of heat storage device; and, in response to the received signal and the detected discharge state, storing at least a portion of the excess electrical energy in the form of latent heat in the heat storage device. Further provided are a heat storage device and a system comprising a plurality of heat storage devices for implementing the above method.

### TECHNICAL FIELD

The invention relates to the field of energy storage. Specifically, there is described a technology for decentrally storing energy provided by at least one centrally arranged energy generation facility for generating electrical energy.

### BACKGROUND

Renewable energy sources, such as, for example, photovoltaic systems or wind turbines are increasingly gaining in importance. They are gradually replacing conventional power plants, such as nuclear power plants or thermal power plants, which rely on burning fossil energy sources. Conventional power plants have the advantage that they can produce a desired amount of electrical energy at any time (i.e. regardless of the time of day or season) and feed it into a power grid. In conventional power plants, the generation and supply of electrical energy into the power grid takes place on demand. To be able to provide sufficient electrical energy to end consumers at any time, reliable predictive models are needed that can predict the energy demands within the power grid at any time of the day or for any season. The conventional power plants can be operated according to the expected energy demand.

The on-demand generation of electrical energy described in connection with conventional power plants is difficult to implement with renewable energy sources, such as photovoltaic systems or wind turbines. In fact, with renewable energy sources, the energy generation depends on the presence of natural energy resources, such as, for example, solar radiation for photovoltaic systems or wind power for wind turbines. The natural energy resources depend on the time of day (day/night), season and weather (sunshine, rain, wind) and cannot be influenced by humans. Accordingly, the amount of electrical energy generated and provided by the renewable energy sources is subject to larger fluctuations. For example, at specific times, the electrical energy generated from renewable energy sources can by far exceed the energy demands of end users within the power grid. Similarly, due to the lack or absence of natural energy resources (e.g., lack of solar radiation at night time, lack of wind), there may be times when energy generation is much lower than energy consumption.

To enable an efficient use of renewable energy sources nonetheless, it is desirable to temporarily store unused energy production peaks that occur during the generation process and make them available to end users during times of low energy generation. Preferably, chemical battery cells are used for storing excess energy or energy peaks. However, they are expensive to buy. Furthermore, the storage capacity of battery cells decreases with every new charge cycle. It is also known in the art to temporarily store the excess energy from renewable energy sources by means of water storage power plants.

It is the object of the present invention to provide an alternative storage technology that is configured to store excess electrical energy, which is preferably generated by renewable energy sources, flexibly, for the long-term and without losses.

### BRIEF SUMMARY

This object is achieved according to a first aspect by a method for the decentralized storage of energy provided by at least one centrally arranged energy generation facility for generating electrical energy. To this end, the method according to the invention comprises the following steps: providing at least one heat storage device, wherein the heat storage device is arranged decentrally with respect to the energy generation facility and electrically coupled to the energy generation facility; receiving a signal provided by the energy generation facility by the at least one heat storage device, the signal indicating the presence of excess electrical energy at the energy generation facility; detecting the current discharge state of the heat storage device; and, in response to the received signal and the detected discharge state, storing at least a portion of the excess electrical energy provided by the energy generation facility in the form of latent heat in the heat storage device.

A centrally arranged energy generation facility is understood to mean an energy generation facility that is arranged spatially remote from the end users. A wind turbine (e.g., a wind farm), a solar power plant (e.g., a photovoltaic system) or any other energy generation facility capable of using renewable energies to generate large quantities of electrical energy may be used as an energy generation facility. However, the energy generation facility may also comprise a conventional power plant, such as a nuclear power plant or a thermal power plant.

Excess electrical energy is understood to mean the electrical energy or energy fraction generated by the energy generation facility that is not immediately consumed by the end users at the time of generation. Whether excess energy is generated at a specified time thus depends on the amount of energy that is generated and provided by the energy generation facility and on the amount of energy consumed by the end users at said specified time. Excess energy can occur in a regenerative energy generation facility especially if the weather parameters relevant for the regenerative energy generation facility, such as the intensity of solar radiation for photovoltaic systems or the wind strength and wind direction for wind turbines, reach optimal values for the energy generation facility. In this case, the regenerative energy generation facility can achieve its maximum energy production and, consequently, the generation of a maximum amount of energy for that energy generation facility (so-called energy production peaks). When energy production peaks occur, there may be a considerable amount of excess energy, which is not immediately consumed by the end users.

The at least one heat storage device is arranged centrally relative to the energy generation facility. Decentralized in this context means that the heat storage device is arranged (and/or installed) at or near an end user. In contrast to the centrally arranged energy generation facility, which is provided for the centralized supply of a plurality of end consumers, the at least one decentrally arranged heat storage device is provided for supplying end users with thermal energy on site. If several heat storage devices are provided, they may be spaced apart and distributed over several end users.

The step of storing at least a portion of the excess electrical energy provided by the energy generation facility in the form of latent heat can further comprise tapping and converting electrical energy into thermal energy. The conversion of electrical energy can take place locally at the at least one energy generation facility. For this purpose, the energy generation facility can comprise an energy conversion unit configured to convert electrical energy into thermal energy. For example, a heating element, a heating coil or any other element which can be heated with electrical energy can be used as an energy conversion unit.

The electrical coupling between the centrally arranged energy generation facility and the at least one decentrally arranged heat storage device can be achieved via an existing (conventional) power grid.

The presence of excess electrical energy (e.g., in case of energy production peaks) can be signaled by the centrally arranged energy generation facility to the at least one decentrally arranged heat storage device. The signaling can occur via a signal. This signal can be communicated via a separate network (e.g., via the internet via an IP signal) or via the power grid to the at least one heat storage device.

Storing at least a portion of the excess electrical energy that is provided by the energy generation facility in the form of heat can only be achieved if when the at least one decentrally arranged heat storage device is ready for storing the excess electrical energy. Typically, the at least one decentrally arranged heat storage device will be ready only if the discharge state of the at least one heat storage device reaches or exceeds at least one predefined threshold.

The at least one heat storage device can signal the central energy generation facility regarding its readiness to accommodate excess electrical energy. The signaling of the readiness to accommodate excess energy can be in response to a signal received from the energy generation facility that is indicative of the presence of excess energy. The at least one heat storage device can communicate its readiness to accommodate excess energy by means of a signal (response signal) it sends to the centrally arranged energy generation facility. In addition to readiness information, the response signal can also contain information about the amount of energy that it can accommodate from the central energy generation unit and store. The amount of energy that can be accommodated by the heat storage device is a function of the discharge state of the heat storage device.

To ascertain the readiness for storing excess energy in the form of thermal energy, the method can further comprise detecting a current discharge state of the at least one heat storage device. This step of detecting the current discharge state of the at least one heat storage device can be performed in response to a signal received by the central energy generation facility. Thus, electrical energy can be tapped from the power grid and converted into thermal energy, every time when the heat storage device is in a discharge state that enables accommodating a minimum amount of energy.

The method can further comprise on-demand providing of the thermal energy stored in the at least one heat storage device to a local end user. In other words, according to the present method, excess electrical energy can be decentrally stored in the form of thermal energy and, if required, provided to a decentralized end user.

According to one implementation, a plurality of decentrally arranged heat storage devices can be provided that are electrically coupled to the energy generation facility. Each of the plurality of heat storage devices can receive the signal that is provided by the energy generation facility, detect its current discharge state, and store, in response to the received signal and its detected charge state, at least a portion of the excess electrical energy provided by the energy generation facility in the form of thermal energy.

According to another aspect, a device for storing energy is provided, wherein the device can be coupled via a power grid to at least one centrally arranged energy generation facility for generating electrical energy. The device comprises: a receiver configured to receive a signal provided by the energy generation facility, the signal being indicative of the presence of excess electrical energy at the energy generation unit; a sensor unit configured to detect a current discharge state of the heat storage device; a heat storage unit configured to store thermal energy in the form of latent heat; and a control unit configured to trigger, based on the received signal and the detected discharge state, the heat storage unit to store at least a portion of the excess electrical energy provided by the energy generation facility in the form of latent heat.

The heat storage device is configured as a latent heat storage device. It comprises a latent heat storage medium provided to store energy in the form of latent heat. A salt hydrate, preferably sodium acetate trihydrate, can be used as the latent heat storage medium. Such salt hydrates have proven successful, since they are, on the one hand, less expensive to buy and, on the other hand, have a high heat storage capacity. By storing heat in the form of latent heat, it is possible, in particular, to store energy in the form of heat, without losses and for long periods of time.

The heat storage device can further comprise an energy conversion unit configured to convert electrical energy into thermal energy. Such an energy conversion unit can be, for example, a heating element, which heats up when a current flows through it and releases heat to the outside. In this case, the energy conversion unit can be (thermally) coupled to the latent heat storage medium of the heat storage device. Thus, the heat generated by the energy conversion unit is directly (i.e. without interim losses) supplied to the latent heat storage medium. Alternatively, it is also conceivable that the energy conversion unit is (thermally) coupled to a heat transfer medium of the heat storage device. In this case, the heat generated by the energy conversion unit is first supplied to the heat transfer medium and then supplied by the heat transfer medium to the latent heat storage medium. Water, oil or other transfer agents can be used as a heat transfer medium.

A conventional signal receiver can be used as a receiver, wherein the signal receiver is configured to receive (and to decode) a wireless or a wireline signal.

A thermal energy consumption meter can be used as a sensor unit that measures the thermal energy tapped off (and supplied) at the latent heat storage. Based on the measured tapped thermal energy and on the knowledge of the maximum energy capacity of the heat storage device, it is possible to determine the current discharge state of the heat storage device.

In response to the detected signal and the detected discharge state, the control unit can further be configured to trigger the energy conversion unit to tap at least a portion of the excess electrical energy provided in the power grid and convert it to thermal energy. In other words, the control unit can calculate, based on the detected discharge state, how much excess energy can be stored by the heat storage device at any rate. Based on this calculation, the control unit can communicate to the energy conversion unit how much electrical energy said unit is to tap from the power grid.

According to another aspect, there is provided a system for the decentralized storage of electrical energy in the form of thermal energy. The system comprises a plurality of heat storage devices, as described above, wherein the plurality of heat storage devices is arranged decentrally with respect to one or several electrical energy generation facilities, and they are electrically coupled thereto via a (conventional) power grid.

According to one variant, each of the heat storage devices of the system is arranged at an energy end user. Common households, industrial installations or other private or public buildings may be the energy end users. The decentralized arrangement of a plurality of heat storage devices can thus provide a grouping of heat storage devices, which are coupled to the centrally arranged energy generation facility via an existing shared power grid. The system or grouping of decentrally arranged heat storage devices thus produced enables storing excess energy in a decentralized and flexible manner via a plurality of heat storage devices. The power generation facility, on the other hand, can flexibly distribute excess energy across a plurality of heat storage devices. Thus, the decentralized energy storage system described herein is flexible in terms of its use and robust against failure; in fact, if one heat storage device fails, it can be compensated by the remaining heat storage devices.

According to one variant, the system described herein can further comprise the energy generation facility in addition to the decentrally arranged heat storage devices that are electrically interconnected via a power grid. The energy generation facility for generating electrical energy can be an energy generation facility based on renewable energy, such as, for example, a wind farm, a photovoltaic system, or even a conventional power plant, such as, for example, a nuclear power plant or a thermal power plant.

### DESCRIPTION OF THE FIGURES

Further details and advantages of the invention will be described in reference to the embodiments shown in the figures.

FIG. 1 shows a schematic representation of a power grid for implementing the present invention;

FIG. 2 shows a block diagram of a heat storage device according to the invention for the decentralized storage of energy; and

FIG. 3 shows a flow chart illustrating a method according to the invention for the decentralized storage of energy.

### DETAILED DESCRIPTION

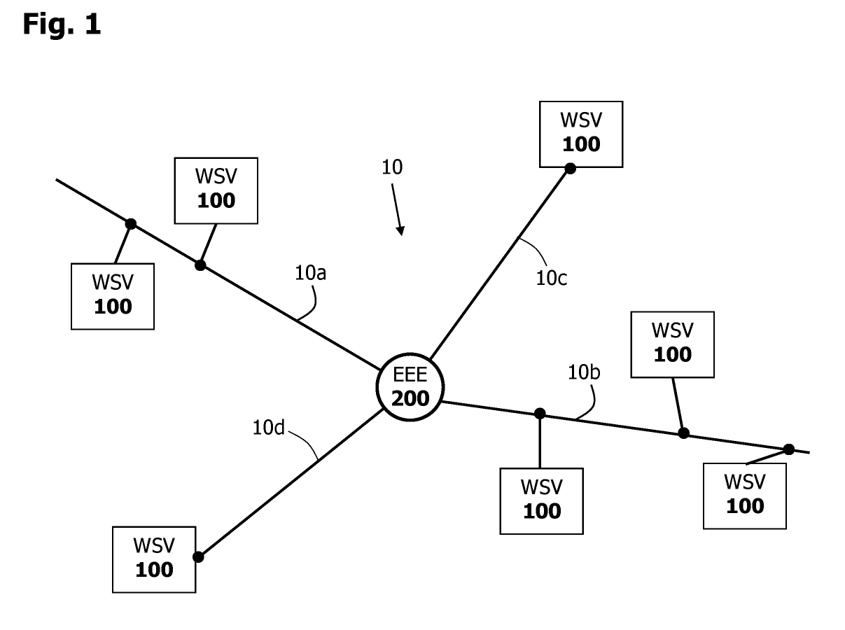

The present invention for the decentralized storage of energy will be further described in connection with FIG. 1. FIG. 1 shows a section of a conventional power grid 10 (or integrated grid) comprising a plurality of electrical power lines 10a-10d configured for the transmission of electrical energy. At least one centrally arranged energy generation facility 200 (abbreviated as “EEE” in FIG. 1) and a plurality of heat storage devices 100 (abbreviated as “WSV” in FIG. 1) are electrically coupled to the power grid 10. The heat storage devices 100 are arranged decentrally with respect to the at least one energy generation facility. They are arranged in or near an end user (not shown in FIG. 1), such as a private or public building, factories, or other facilities.

The energy generation facility 200 may be a conventional power plant or a renewable energy source, such as, for example, a wind farm (offshore or onshore wind farm) or a large-scale photovoltaic system. The power generation facility 200 is provided to generate electrical energy and feed into the power grid 10.

The heat storage devices 100 arranged at the location of or near end users are electrically coupled to the power grid 10. They are provided to store energy in the form of thermal energy. In particular, they are provided to convert electrical energy provided by the at least one energy generation facility 200 into corresponding thermal energy and to store it over the long-term and, ideally, without losses. In particular, the heat storage devices 100 are configured to convert excess electrical energy generated by the energy generation device 200 into thermal energy and store it over the long-term. Each heat storage device 100 is further configured to supply the user associated with the heat storage device 100 on demand with the stored thermal energy.

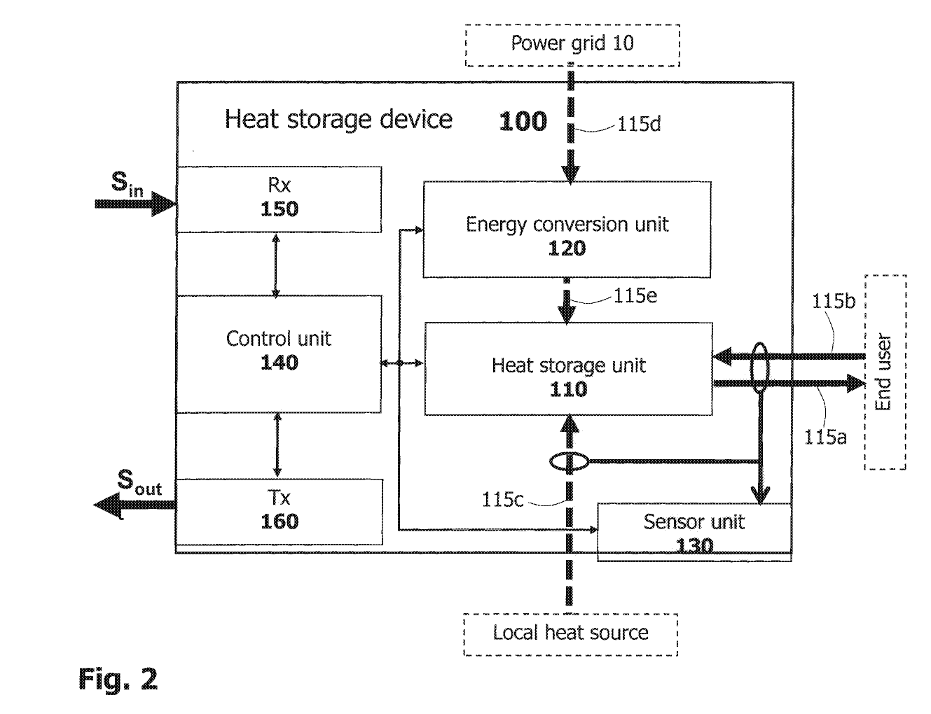

In connection with FIG. 2, the heat storage devices 100 shown in FIG. 1 will now be described further. Each heat storage device 100 comprises a heat storage unit 110, an energy conversion unit 120, and a sensor unit 130. The heat storage device 100 further comprises a control unit 140 and a receiver 150 (abbreviated Rx in FIG. 2). Optionally, the heat storage device 100 can further comprise a transmitter 160 (abbreviated Tx in FIG. 2).

The heat storage unit 110 is configured as a latent heat storage unit. It is configured to store thermal energy in the form of latent (and sensible) heat. For this purpose, the latent heat storage unit can comprise at least one latent heat storage element in which a predefined amount of latent heat storage medium is stored (not shown in the block diagram in FIG. 2). The latent heat storage medium of the at least one latent heat storage element is constituted such that it changes its phase state when thermal energy is supplied; and it stores the energy required in the phase change in the form of latent heat. The amount of heat that can be stored in the form of latent heat depends on the type and amount of the used latent heat storage medium. Preferably, the used latent heat storage medium is a salt hydrate, such as, for example, sodium acetate trihydrate. It can store large amounts of heat in the form of latent heat.

The at least one heat storage element of the heat storage unit 110 is thermally coupled to a heat transfer medium. Water can be used as a heat transfer medium. When charging the heat storage unit 110, the at least one heat storage element (and thus the heat storage medium) is supplied with heat via the heat transfer medium. The supplied heat is absorbed by the heat storage medium and stored wholly or mostly in the form of latent heat. Conversely, the thermal energy stored in the heat storage medium in the form of latent heat can be freed again by changing the phase state; and it can be released to the heat transfer medium surrounding the heat storage elements. The thermal energy released to the heat transfer medium can then be transferred to an end user (for example, heating system in an apartment) via a heat transfer medium circulation. The heat transfer medium circulation, which fluidically couples the end user to heat storage unit 110, is indicated only schematically in the block diagram of FIG. 2 by the arrows 115a and 115b (for the flow and return flow).

Heat storage unit 110 is further thermally coupled to a local heat source, such as, for example, a solar heating system (only schematically indicated in FIG. 2). Heat storage unit 110 can thus be charged by means of the thermal energy provided by the local heat source. This charging process is indicated in FIG. 2 by the dashed arrow 115c.

Furthermore, heat storage unit 110 is coupled to conventional power grid 10, as shown in FIG. 1, via energy conversion unit 120. Energy conversion unit 120 is provided to tap electrical energy provided via power grid 10 (arrow 115d in FIG. 2), convert it to thermal energy and to supply heat storage unit 110 with the converted thermal energy (arrow 115e). Thus, the heat storage unit 110 can also be charged by converting electrical energy provided via power grid 10 into thermal energy.

To be able to convert electrical energy into thermal energy, energy conversion unit 120 comprises at least one heating element or other heating element that can be electrically operated and converts electrical energy into heat. To be able to release the converted thermal energy to the heat storage medium ideally without losses, the conversion facility can be in direct contact with the heat transfer medium or the heat storage medium.

Sensor unit 130 is configured to measure the amount of heat released by heat storage unit 110 to an end user. It is further configured to measure the amount of heat supplied to heat storage unit 110 via the local heat source and/or energy conversion unit 120. As indicated in FIG. 2, for this purpose, the sensor unit 130 is coupled with the corresponding heat transfer medium circulations which fluidically connect the heat storage unit to the end user and to the local heat source and/or energy conversion unit 120. The discharge state or charge state of heat storage unit 110 can be determined at any time from the difference of the measured amount of heat supplied to and extracted from heat storage unit 110.

Transmitter 160 and receiver 150 are provided for the communication with central energy generation facility 200. Transmitter 160 and receiver 150 can be configured for wireless or wireline communication (that is, for receiving or transmitting communication signals) with energy generation facility 200.

Control unit 140 is in communication with heat storage unit 110, energy conversion unit 120 and sensor unit 130. Control unit 140 is configured to capture sensor signals from sensor unit 130 that indicate inflows and outflows of heat to and from heat storage unit 110. Control unit 140 is further provided to determine the charge state or discharge state of heat storage unit 110 based on the captured heat flows by sensor unit 130. Control unit 140 is further provided to trigger the energy conversion unit 120, based on the determined discharge state and/or charge state of heat storage unit 110, such that energy conversion unit 120 taps a predefined amount of electrical energy from power grid 10, which corresponds to a converted amount of heat that results in the full or at least partial charging of heat storage unit 110.

Control unit 140 is further coupled to receiver 150 to receive (and evaluate) a signal Sᵢₙ from central energy generation facility 200. Furthermore, control unit 140 may be coupled to transmitter 160 in transmit a response signal Sₒᵤₜ of energy generation facility 200 generated by control unit 140.

To perform the functions described above, control unit 140 has a processor and a memory. The communication signals as well as the measured values are temporarily stored in the memory. The processor is provided for processing the control functions.

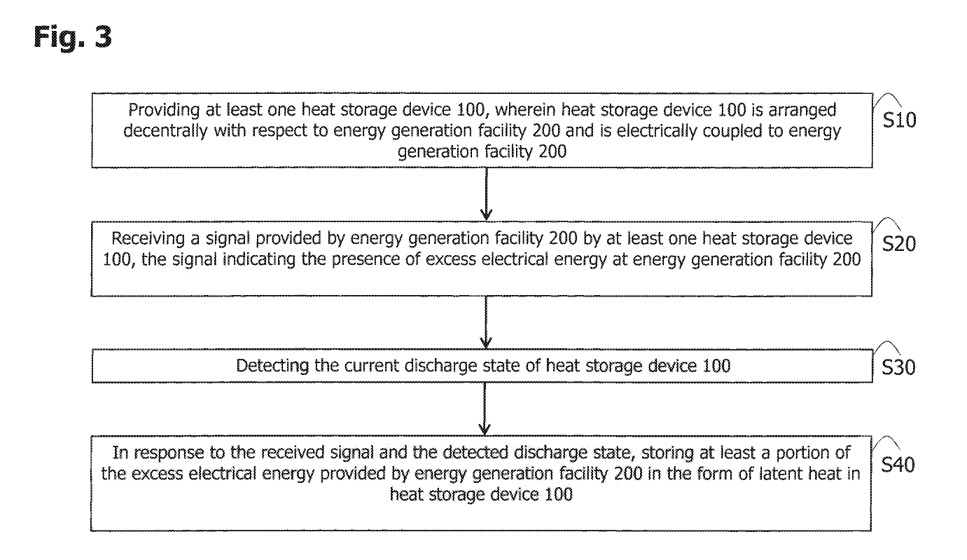

In connection with FIG. 3, there is described a method according to the invention for the decentralized storage of energy in an existing, conventional power grid (such as, for example, illustrated in FIG. 1). The method illustrated in FIG. 3 is implemented by means of heat storage device 100 shown in FIG. 2.

According to a first step, there is provided at least one heat storage device 100. Providing is understood to mean the coupling of the at least one heat storage device 100 to power grid 10. The at least one heat storage device 100 provided corresponds, in terms of its components and properties, to the heat storage device described in connection with FIG. 2. The at least one heat storage device 100 is arranged decentrally with respect to power generation device 200 in existing power grid 10. Decentralized is understood to mean that heat storage device 200 is arranged in or near the end user in power grid 10, as illustrated in FIG. 1. Heat storage device 100 is in electrical communication with centrally arranged energy generation facility 200 via existing (conventional) power grid 10.

In a further step S20, a signal Sᵢₙ provided by energy generation facility 200 is received by means of receiver 150 of heat storage device 100. Signal Sᵢₙ indicates the presence of excess electrical energy at energy generation facility 200. In other words, signal Sᵢₙ is always sent by energy generation facility 200 when excess electrical energy is available at energy generation facility 200, which is not immediately needed by any user in the power grid.

In a subsequent step S30, the current discharge or charge state of heat storage device 100 (more specifically, heat storage unit 110) is detected using sensor unit 130 and control unit 140 of heat storage device 100. The step of detecting can comprise a read-out of sensor unit 130, which measures the heat inflow to heat storage unit 110, as well as heat outflow from heat storage unit 110. The step of detecting can further comprise calculating the discharge and/or charge states from the measured heat inflow and heat outflow using control unit 140. The calculation of the discharge state can be performed, for example, by determining the difference of measured heat inflow relative to heat outflow. The detecting step can be performed in response to a received signal Sᵢₙ.

Depending on the detected discharge state and/or charge state and in response to the received signal Sᵢₙ, control unit 140 decides in a subsequent fourth step S40 whether a portion of the excess energy provided by energy generation facility 200 should be stored in the form of latent heat in heat storage unit 110. If control unit 140 determines, based on the measurement signals of sensor unit 130, that the discharge state and/or charge state of heat storage unit 110 exceeds a predefined threshold value control unit 140 calculates the amount of energy that can be stored by partially or completely discharged heat storage unit 110. Based on this calculation, control unit 140 triggers energy conversion unit 120 to extract that amount of energy from power grid 10 which is required to recharge heat storage unit 110, entirely or at least partially.

In response to received signal Sᵢₙ of energy generation facility 200, control unit 140 can further send a response signal Sₒᵤₜ to energy generating facility 200 via transmitter 160. The response signal Sₒᵤₜ can contain information that is indicative of an amount of energy that heat storage device 100 is ready to tap and store in the form of latent heat. Alternatively, it is also conceivable that energy generation facility 200 offers in signal Sᵢₙ an amount of electrical energy predefined by energy generation facility 200. Based on the detected discharge state of heat storage unit 110, control unit 140 can then decide whether it wants to tap the amount of energy offered by central energy generation facility 200 for interim storage in the form of latent heat. In this case, response signal 160 can comprise only information that is indicative of the acceptance or rejection of the offer.

According to one implementation, a plurality of heat storage devices 100 described above can be provided in power grid 10, wherein the method described in connection with FIG. 3 is implemented in each of the plurality of heat storage devices 100. The plurality of heat storage devices 100 thus forms a decentrally arranged heat storage system or heat storage cluster. Each of the plurality of heat storage devices 100 is in communication with and capable of communicating with the at least one energy generation facility 200 provided in power grid 10. In case of energy production peaks occurring at the at least one energy generation facility 200, energy generation facility 200 can send a signal Sᵢₙ indicating the energy production peaks to each of the heat storage devices 100. Each of the plurality of heat storage devices 100 can then decide, based on the discharge state measured for each heat storage device 100, whether and how much energy it would like to accommodate for the interim storage of electrical energy in the form of latent heat.

The invention described here enables the storage of excess electrical energy in the form of thermal energy, decentrally near the end user. The decentralized storage technology described herein is, furthermore, supply-driven and not on-demand-driven, such as in conventional power grids 10. Thus, produced excess energy can be distributed quickly and flexibly across some or many heat storage devices 100 in the grid. Electrical energy production peaks can thus be utilized efficiently.

The flexibility of the decentralized energy storage technology described herein increases with the number of heat storage devices 100 provided within the grid. Providing a plurality of heat storage devices 100 (e.g., several hundreds or thousands of heat storage devices) and clustering them increases, of course, the total storage capacity. Thus, a cluster of heat storage devices is also suitable for the interim storage of energy production peaks at large power generation facilities. Furthermore, the clustering of the heat storage devices is advantageous because a failure of one heat storage device 100 (for example, due to a defect or maintenance) can be nicely compensated by the presence of the remaining heat storage devices 100.

Further, since each provided heat storage device 100 is configured as a latent heat storage device, a further advantage is that excess electrical energy can be stored for long-term periods, ideally without losses, and without much wear. Possible losses are primarily the result of energy conversions from electrical to thermal energy. The storage of the electrical energy in the form of latent heat has a further advantage over chemical storage cells. Because latent heat storage means that are based on salt hydrates do not degenerate (no memory effects); and they are dischargeable and rechargeable, respectively, any number of times. The storage capacity of heat storage device 100 does not appreciably decrease in this instance. In this respect, the invention described herein provides a robust and durable piece of technology that is also inexpensive in comparison to chemical storage cells.

I claim:

1. A method for the decentralized storage of energy provided by at least one centrally arranged energy generation facility for generating electrical energy, the method comprising the steps of:
providing at least one heat storage device, wherein the heat storage device is decentrally arranged with respect to the energy generation facility and electrically coupled to the energy generation facility;
receiving a signal provided by the energy generation facility by at the at least one heat storage device, the signal indicating the presence of excess electrical energy at the energy generation facility;
detecting the current discharge state of the heat storage device; and
in response to the received signal and the detected discharge state, storing at least a portion of the excess electrical energy provided by the energy generation facility in the form of latent heat in the heat storage device.

2. The method according to claim 1, wherein the step of storing further comprises tapping and converting the electrical energy into thermal energy.

3. The method according to claim 1, wherein the electrical coupling between the centrally arranged energy generation facility and the at least one decentrally arranged heat storage device is achieved via a conventional power grid.

4. The method according to claim 1, wherein the excess electrical energy comprises electrical energy peaks that occur during the generation of electrical energy by means of regenerative power generation sources.

5. The method according to claim 1, wherein the at least a portion of the excess electrical energy provided by the energy generating device is stored in the form of heat only if the discharge state reaches or exceeds at least one predefined threshold value.

6. The method according to claim 1, wherein the step of detecting the current discharge state of the heat storage device is performed in response to the received signal.

7. The method according to claim 1, further comprising on-demand-dependent providing of the thermal energy stored in the at least one heat storage device to a local end user.

8. The method according to claim 1, wherein a plurality of decentralized heat storage devices that are electrically coupled to the energy generation facility are provided,
and wherein each of the plurality of heat storage devices receives the signal provided by the energy generation facility, detects its current discharge state and stores, in response to the received signal and its detected discharge state, at least a portion of the excess electrical energy provided by the energy generation facility in the form of thermal energy.

9. A heat storage device, wherein the heat storage device is connectable to at least one centrally arranged energy generation facility for generating electrical energy via a power grid, and wherein the heat storage device comprises:
a receiver configured to receive a signal provided by the energy generation facility, the signal being indicative of the presence of excess electrical energy at the energy generation facility;
a sensor unit configured to detect a current discharge state of the heat storage device;
a heat storage unit configured to store thermal energy in the form of latent heat; and
a control unit configured to trigger, based on the received signal and the detected discharge state, the heat storage unit in such a way that it stores at least a portion of the excess electrical energy provided by the energy generation facility in the form of latent heat.

10. The heat storage device according to claim 9, further comprising an energy conversion unit configured to convert electrical energy to thermal energy.

11. The heat storage device according to claim 10, wherein the control unit is further configured to trigger, in response to the captured signal and the detected discharge stage, the energy conversion unit in such a way that it taps at least a portion of the excess electrical energy provided in the power grid and converts it to thermal energy.

12. A system for the decentralized storage of electrical energy in the form of thermal energy, the system comprising a plurality of heat storage devices according to claim 9, wherein the plurality of heat storage devices is decentrally arranged with respect to an electrical energy generation facility and electrically coupled thereto via a power grid.

13. The system according to claim 12, wherein each of the heat storage devices is arranged at an energy end user.

14. The system according to claim 12, further comprising the energy generation facility for generating the electrical energy.
